(19) United States
(12) Patent Application Publication
(10) Pub. No.: US 2011/0255812 A1
(43) Pub. Date: Oct. 20, 2011

(54) Bearing Assembly for a Disk Gang

(76) Inventors: Richard J. Connell, Slater, IA (US); Anthony S. Royer, Minburn, IA (US); Mark D. Beeck, Ankeny, IA (US); Kyan A. Hackert, Oskaloosa, IA (US)

(21) Appl. No.: 12/761,168

(22) Filed: Apr. 15, 2010

(51) Int. Cl. F16C 17/02; F16C 35/02

(52) U.S. Cl. 384/157

(57) ABSTRACT

A bearing assembly (20) with a self-lubricated liner interface (70) supported between a spherical outside surface (72) of a sealed agricultural bearing (20b) and a steel containment housing (60,62). The interface (70) includes a lubrication-impregnated plastic interposed between the housing (60,62) and the spherical surface (72) to relieve the bearing from the high forces of shaft misalignment. The plastic liner includes a compressible portion such as radially projecting protrusions (82), O-rings (82a) or other resilient band, or compressible molded plastic (H2) to accommodate varying tolerances between the outside spherical surface (72) and housing cavity surfaces (68) and liner (70) and to bias the liner (70) against the spherical surface (72) to prevent bearing rotation. The plastic liner halves (70a,70b) fit firmly over the outside bearing surface to reduce entry of dirt and contaminants into the housing and onto the spherical bearing surface (74). The sealed bearing (20b) and self-lubricated interface (70) eliminate need for external grease ports.

### FIELD OF THE INVENTION

The present invention relates generally to disk implements and, more specifically, to a disk bearing mounting.

### BACKGROUND OF THE INVENTION

A disk gang typically includes an arbor bolt or shaft supported by standard-mounted spherical bearings located between disks spaced along the length of the shaft. The spherical bearings are designed to facilitate self-alignment during assembly of the disk gang and to allow some oscillation from an initial in-line alignment as the gang shaft axis shifts with variable shaft loading as the disks impact objects and as ground conditions vary. In most previously available disk bearing assemblies, a lubrication point such as a grease fitting or oil reservoir is provided and requires regular maintenance. The maintenance procedures can be awkward and time-consuming.

Tolerances between the outer surface of the disk bearing and bearing mounting frequently cause problems. Without careful and expensive manufacturing processes, the stacked tolerances between the bearing inserts and housing often can result in a loose fit that allows the entire bearing to rotate with the shaft within the housing. As a result, the bearing assembly will fail prematurely. In addition, lubrication is required between the housing and the spherical outer surface of the bearing to facilitate bearing self-alignment to accommodate shaft misalignments caused by axis tolerances and the slight shifting of the axis during operation as the loading on the gang varies. Without the proper lubrication between the housing and bearing, a spherical radius bearing will wear on the outside diameter, and eventually fail due to friction from rotating in the housing.

### SUMMARY OF THE INVENTION

A self-lubricated liner interface is supported between a spherical outside surface of an agricultural bearing and a steel containment housing. The steel containment housing protects the bearing and interface from dirt and field residue. The interface is fabricated from a lubrication-impregnated plastic and is interposed between the steel housing and the spherical surface to facilitate radial sliding for dynamic self-alignment of the bearing to relieve the bearing from the high forces of shaft misalignment. Radially projecting members extend beyond a generally spherical surface of the liner to accommodate varying tolerances between the outside spherical surface of the bearing and the housing and liner and to bias the interface into gripping relationship with the bearing prevent the bearing from rotating about the shaft axis relative to the containment housing.

In one embodiment a radially split liner includes halves assembled over the spherical outside surface of the bearing. The liner has protrusions to bias the liner into gripping relationship with the bearing surface and eliminate problems caused by tolerance stacking. Anti-rotation locator tabs fit in corresponding recesses in a two-piece containment housing assembled over the halves. In another embodiment, each of the halves receive a tolerance-accommodating cushion member such as an O-ring in a groove formed in the half. The protrusions or cushion members help bias the liner against the outer surface of the bearing to provide sufficient grip between the housing and the spherical outside surface of the bearing to prevent the bearing from rotating within the housing. The plastic liner halves have outwardly directed circular openings that fit firmly over the bearing surface and provide seals between the surface and the openings on the opposite sides of housing to reduce or eliminate entry of dirt and contaminants into the housing and onto the spherical bearing surface. By using a sealed lubricated bearing in combination with a self-lubricated liner protected from contamination, external grease ports can be eliminated and maintenance requirements are reduced.

In one embodiment, a lubrication impregnated plastic is integrally molded in the steel housing to provide a self lubricated interface between a spherical outside diameter bearing and the containment housing. Eliminating the machined surfaces on a cast bearing housing reduce need for secondary machining operations and reduce part cost. A lubrication impregnated plastic can be dually molded with a plastic or rubber material with a lower durometer. The lubricated high strength plastic would provide a rugged, long-wearing contact surface for the spherical diameter of the bearing, while the second portion of the bearing liner would provide material that can be displaced within depressed sections of the housing. An interference fit is thereby established between the liner and housing that creating a tight grip on the bearing, but allowing it to rotate spherically. The steel housing provides a protection system for the bearing and liner system from soil and field residue, while the interface between the liner and bearing remains free to slide radially to provide a dynamic self alignment of the bearing to relieve the bearing from the high forces of shaft misalignment.

The containment housing protects the bearing and liner system from soil and field residue, while the interface between the liner and bearing remains free to slide radially for dynamic self-alignment that relieves the bearing from the high forces of shaft misalignment. The addition of a plastic liner integrally connected to the bearing housing eliminates the need for any secondary machining operation for tighter tolerances in the main housing to capture the bearing. The plastic liner eliminates the need for lubricant and therefore the problems of dirt and debris adhering to the surfaces and causing wear is reduced. The problem of dirt causing liner and bearing surface wear is also lessened because the liner can compress.

These and other objects, features and advantages of the present invention will become apparent from a reading of the description which follows when taken with the drawings.

### BRIEF DESCRIPTION OF THE DRAWINGS

FIG. 1 is a perspective view of a portion of a disk gang assembly.

FIG. 2 is an exploded view of the disk gang assembly shown in FIG. 1 showing the disk shaft liner and support bearing.

FIG. 3 is an enlarged view of the liner and adjacent spacers removed from the disk shaft.

FIG. 4 is a view similar to FIG. 1 but with the bearing assembly partially disassembled to more clearly show the interface between the bearing and the containment housing.

FIG. 5 is an exploded view of the bearing assembly of FIG. 4.

FIG. 6 is an enlarged perspective view of a portion of the bearing assembly of FIG. 4.

FIG. 7 is a view similar to that of FIG. 6 but showing an alternate embodiment of the interface.

FIG. 8 is an exploded view of another embodiment of the invention wherein the interface is molded directly into the containment housing.

### DESCRIPTION OF THE PREFERRED EMBODIMENT

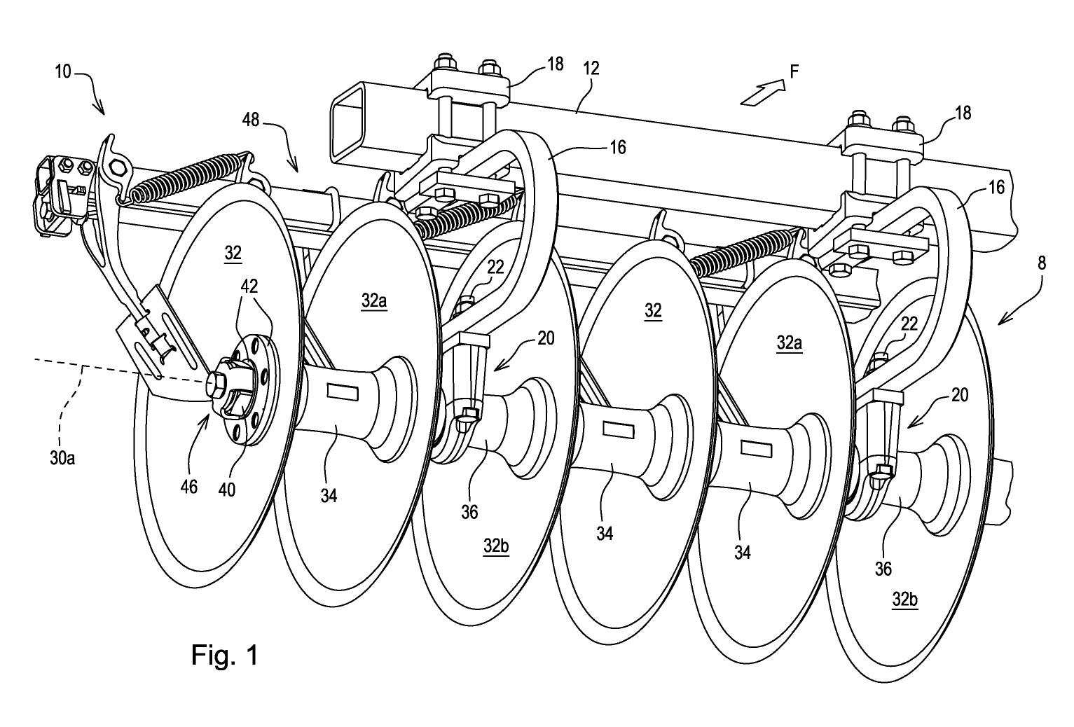

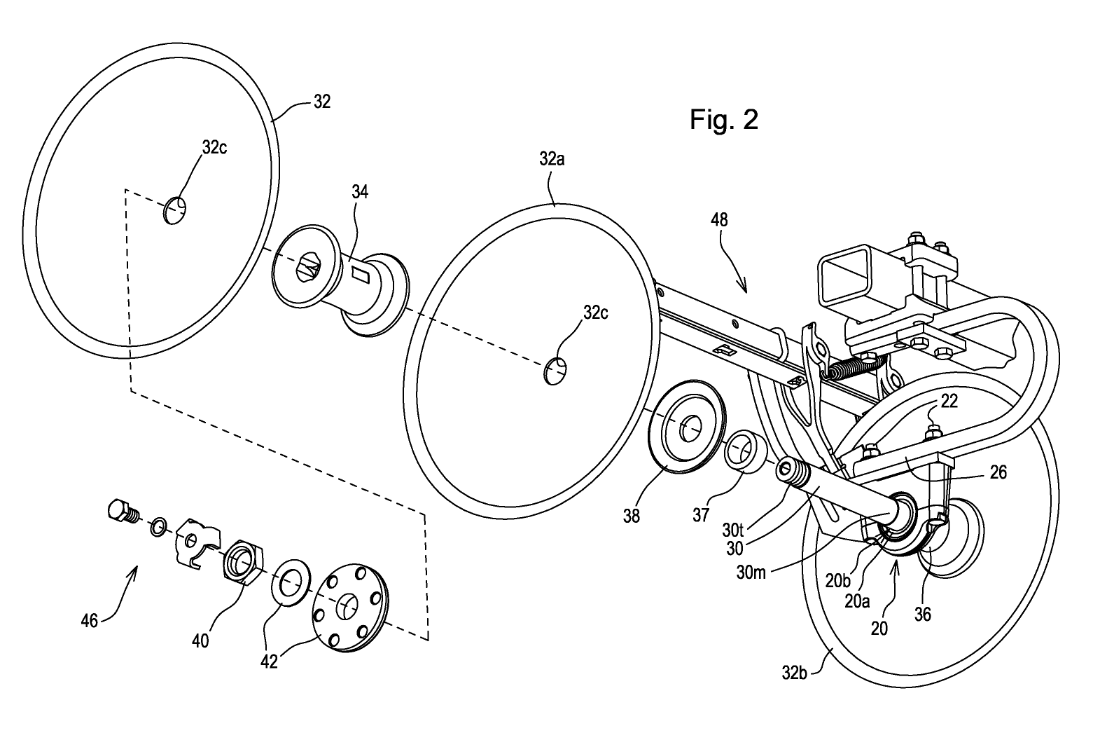

Referring to FIG. 1, therein is shown a portion of an agricultural disk 8 with a disk gang assembly 10. The disk 8 includes a disk frame 12 adapted for movement in the forward direction F over the ground to till the ground, break up clods, and incorporate plant residue into the soil. The frame 12 extends generally transversely to the forward direction F and supports a plurality of spaced C-spring gang mounting standards 16 made of spring steel. The standards 16 include upper ends connected by mounting brackets 18 to the frame 12.

A disk gang bearing assembly 20 includes a bearing 20b with a bearing inner race 20a is connected by bolts 22 to a lower horizontally extending leg 26 of each of the standards 16. A disk gang bolt or shaft 30 with an axis 30a extends through the inner race 20a of the bearing assemblies 20 and supports a plurality of transversely spaced disk blades 32, 32a and 32b having central circular apertures 32c received over the shaft 30. Spacing components 34, 36, 37 and 38 are interposed between the disk blades 32, 32a and 32b. As shown, the spacing component 34 comprises a full spool sandwiched between a pair of adjacent disk blades at locations other than the locations of the bearing assemblies 20. The spacing component 36 is a half spool positioned between inner race 20a of the bearing assembly 20 and the hub of the adjacent disk blade 32b. The components 37 and 38 include a cylindrical spacer and a washer, respectively, sandwiched between the inner race 20a and the hub of the disk blade 32a. A tensioning nut 40 is tightened on a threaded end 30t of the disk gang shaft 30 against end washers 42 abutting the outermost disk blade 32 to sandwich the mounted disk blades 32, 32a and 32b, spacing components 36, 37 and 38 and inner races 20a of the supporting bearing assemblies 20 for rotation in unison about the shaft axis 30a. A nut retaining assembly 46 is supported in the end of the shaft 30 to prevent the tensioning nut 40 from unthreading from the shaft. A conventional disk blade scraper assembly 48 is supported from the frame 12 for clearing mud and debris.

As shown, the disk gang shaft 30 has a cylindrical surface. The inner diameter of the inner race 20a is slightly larger than the shaft diameter to receive the shaft 30 and accommodate manufacturing tolerances between the inner race 20a and the shaft 30. As a result, slight gaps may exist at a mounting portion 30m between the shaft 30 and the inner race 20a. The harsh operating environment of an agricultural disk and the subjection of the disk gang assembly 10 to corrosive conditions can result in damage to the mounting portion 30m and corrosion between the surface 30c of the mounting portion and the inner race 20a.

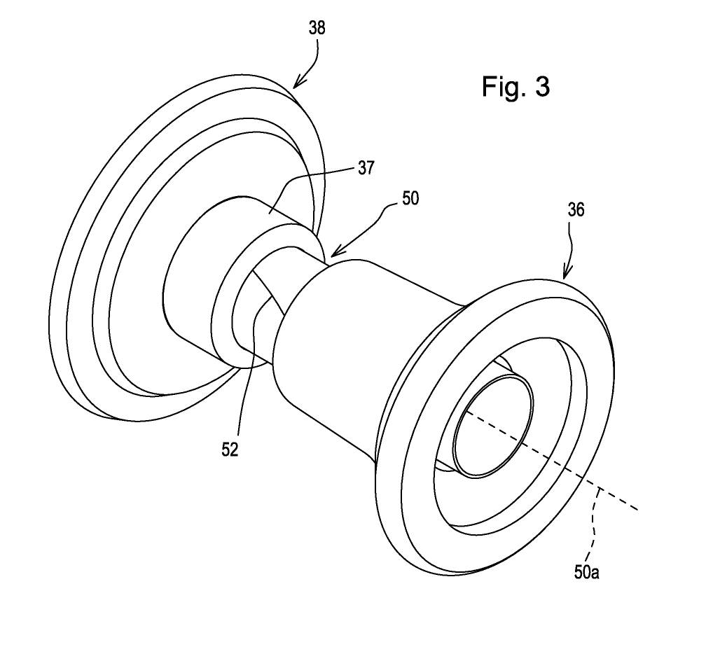

To fill any gaps between the inner race 20a and the mounting portion 30m, prevent seizure of the bearing relative to the shaft 30, and reduce damage to the mounting portion, an anti-corrosive shaft liner 50 is supported over the mounting portion 30m between the disk bearing inner race 20a and mounting portion. The shaft liner 50 is described in our co-pending and commonly assigned patent application Ser. No. 12/722,687, filed 5 Mar. 2010 and entitled Shaft Alignment and Anti-Corrosion Liner for a Disk Gang. The liner 50 is shown as a plastic cylinder with an axis 50a and an inner circumference approximately equal to the circumference of the mounting portion 30m. To facilitate assembly of the liner 50 to the shaft 30 with completely disassembling the disks 34 and components 36 and 38 from the shaft 30, the liner 50 may be spit as shown at 52 in FIG. 3 generally parallel to or at a slight angle relative to axis 50a of the cylinder and axis 30a of the disk gang shaft 30. The shaft liner 50 is formed from a tough plastic such as polyvinylchloride or similar material that is resistant to corrosion but is sufficiently flexible to fill the area of any gaps between the inner race 20a and the shaft surface 30c.

As shown in FIG. 3, the length of the liner 50 is selected to span the inner race 20a and project into the shaft-mounted spacer components 36, 37 and 38 adjacent the bearing assembly 20 to help take up tolerances between the inner diameters of the mounted components and the outer surface 30c of the shaft 30. In the configuration shown, the spacer component 37 fits snugly over the liner 50 and abuts the inner circumference of the component 38. The liner 50 also helps center the bearing inner race 20a and the components 36, 37 and 38 on the shaft 30 during assembly and protects the shaft 30 from damage. Slight misalignments between the shaft 30 and one or more of the spacing components 34, 36, 37 and the bearing inner race 20a can be accommodated by the shaft liner 50.

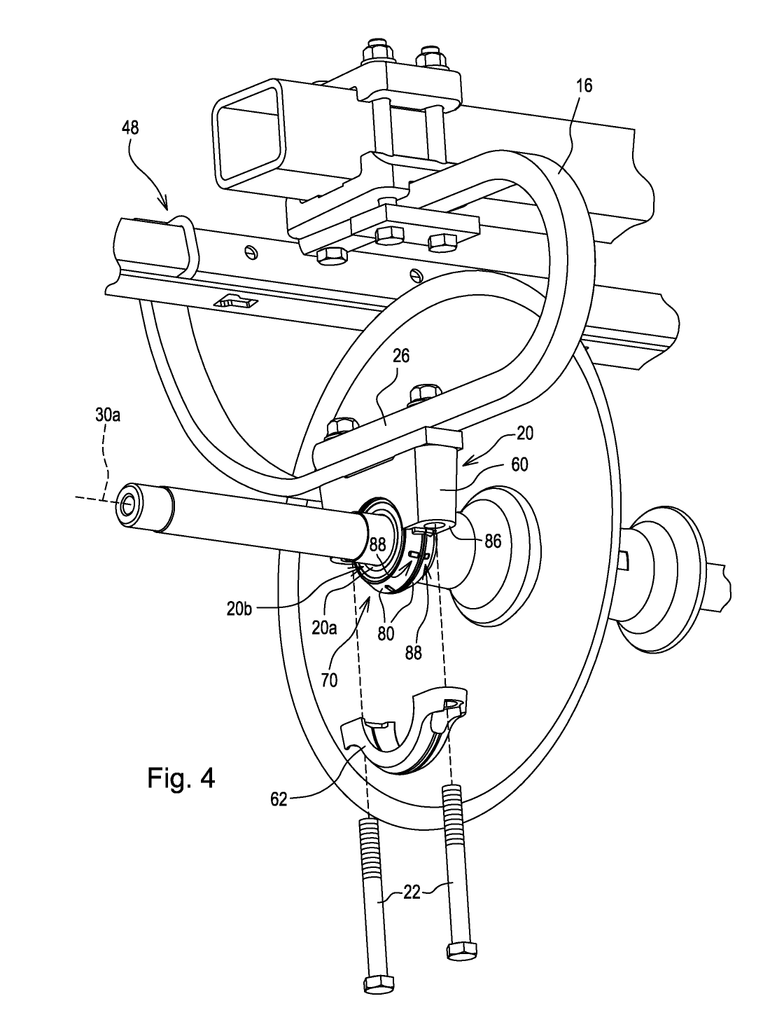

Referring now to FIGS. 4-8, the disk gang bearing assembly 20 will be described in further detail. The bearing assembly 20 includes mating upper and lower containment housing sections 60 and 62, respectively, having a bearing housing cavity 66 defined by cavity surfaces 68. A bearing liner 70 is interposed between an outer surface 72 of a spherically shaped outer race 74 of the bearing 20b and the surfaces 68 defining the bearing housing cavity 66. The bearing liner 70 is a formed assembly of non-metallic material that includes an inner spherically shaped surface 78 conforming to a portion of the outer spherical surface 72 and an outer portion 80 conforming generally to the housing cavity 66. As shown, the bearing liner 70 is molded from a lubricant-impregnated high strength plastic such as Teflon®-impregnated nylon. The inner spherical surface 78 of the liner 70 and the outer surface 72 of the bearing 20b have radii of approximately equal dimensions and centered at the same point. The outer race ring 74 can oscillate within the bearing liner 70 to facilitate self-alignment of the bearing inner race 20a with the with the shaft axis 30a during assembly of the disk gang assembly 10. In addition, shifting of the shaft axis 30a caused by variable operational loading on the disks 32, 32a and 32b is also accommodated by the mounting. However, to avoid destruction of the liner 70, the outer ring 74 of the bearing must be firmly held against rotation relative to the liner 70.

To provide adequate outer bearing race grip to prevent bearing rotation while allowing bearing self-alignment, the bearing liner 70 is fabricated with at least a portion indicated generally at 82 that can compress to take up manufacturing tolerances between the outer race 74 and the housing cavity 66 and provide a tight grip of the outer race 74 by the liner. Diametrically opposed locator tabs 84 project radially from the liner 70 and are received within mating tab-receiving cavities 85 at planar housing junctures 86.

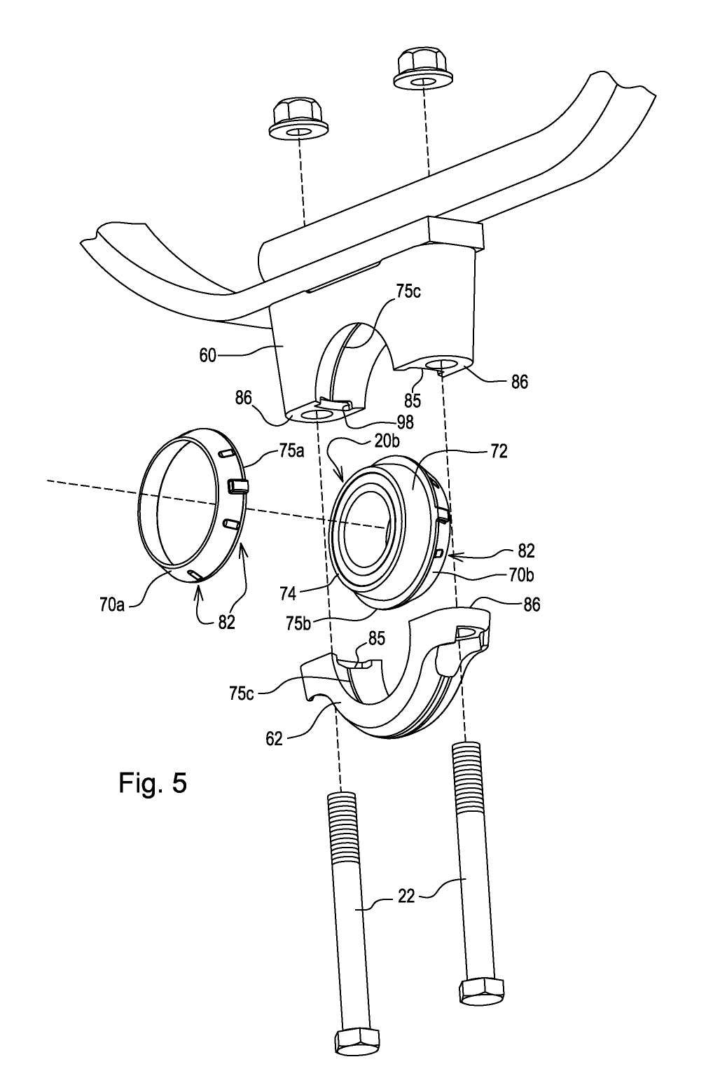

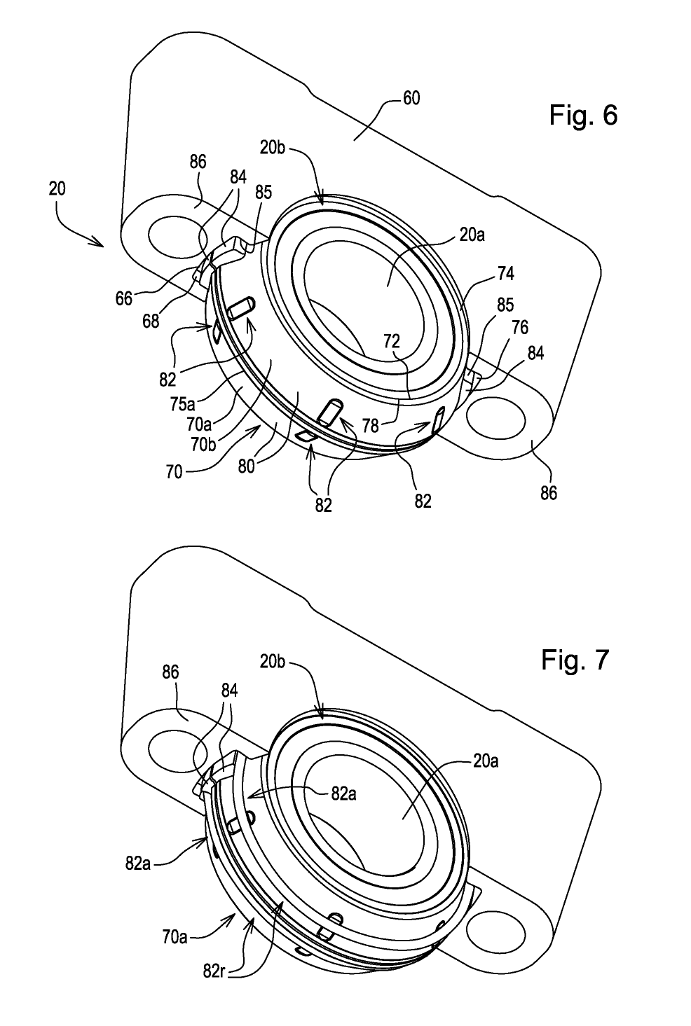

As show in FIGS. 5 and 6, the liner 70 includes identical liner halves 70a and 70b molded from a lubrication-impregnated high strength plastic such as Lubriloy RW-HI. Each half has an innermost planar face lying in a plane generally perpendicular to the shaft axis 30a. The formed halves 70a and 70b are assembled axially over the outer race 74 and abut at radially projecting lips 75a and 75b which are received within mating grooves 75c in the bearing housing cavity. The thickness of the liner 70 is approximately equal to the space between the surfaces 68 of the housing cavity 66 and the outer surface 72 of the outer race 74. The compressible liner portion 82 as shown in FIGS. 5 and 6 includes projections 82p spaced at regular intervals on the outer portion of the liner for accommodating tolerance between the containment cavity 66 of the containment housing and the outer spherical surface of the bearing of the outer race 74. As the bolts 22 are tightened to secure the bearing 20b, the projections 82p bias the inner surfaces of the liner halves 70a and 70b against the spherical surface of the outer race 74 to prevent rotation of the bearing 20b within the housing about the shaft axis 30a. The liner material can compress to fill any gaps that otherwise would exist between the bearing and housing. Alternatively, a compressible liner portion 82a can include O-rings 82r (FIG. 7) or other band structures which provide sufficient biasing to cause the liner 70 to adequately grip the bearing 20b.

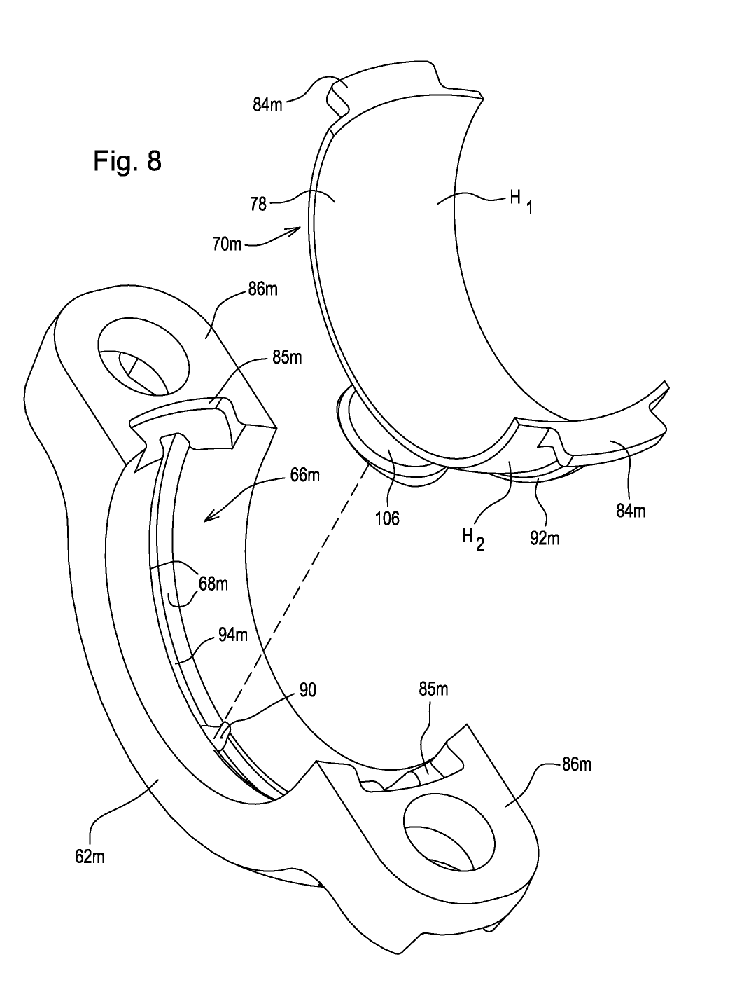

In another embodiment, a liner 70m (FIG. 8) can be integrally molded into a housing cavity 66m having cavity surfaces 68m. The liner 70m can include a first or inner high strength self-lubricating plastic material surface H1 defining the surface 78 and a more compressible second or outer liner portion H2 of a material of durometer less than that of the first plastic material of surface H1 to conform to the cavity 66m and provide sufficient compression to firmly hold the outer race 74 against rotation. A mold or injection port 90 is centrally located in the cavity 66m for injecting the liner material. As shown in the exploded view of FIG. 8, each half liner portion 62m is formed by a corresponding cavity 66m to include a central alignment rib 92m which conforms to a central groove 94m in housing section 62m and radially projecting tabs 84m which are received within mating cavities 85m at planar junctures 86m of the housing section 62m and the corresponding upper housing section (not shown). In the embodiment of FIG. 8, the liner is split along a plane that is generally parallel to the shaft axis 30a. An injection port appendage 106 thermoplastically seals the port 90 and provides added resistance to liner misalignment and rotation. If housing maintenance requires removal and replacement of the liner 70m, the appendage 106 can be severed and the liner 70m removed from the housing cavity 66m for replacement by a standard formed liner conforming to the cavity 66m.

1. In a self-aligning bearing assembly for supporting an implement shaft for rotation about a shaft axis in a harsh operating environment, the shaft axis moveable a limited amount from a first aligned position, the assembly including a bearing with an outer race and an outer spherical surface, a bearing inner race supported within the outer race for rotation about an inner race axis, and a containment housing with housing surfaces defining a containment cavity supporting the outer spherical surface and facilitating movement of the inner race for self-alignment of the inner race axis with the shaft axis as the shaft axis moves from the first aligned position, connecting structure for securing the bearing within the containment housing, the improvement comprising;
a compressible bearing liner having opposed liner surfaces interposed between the outer spherical surface and the housing surfaces of the containment cavity, wherein the bearing liner comprises an inner spherical surface conforming to a portion of the outer spherical surface and an outer portion conforming generally to the containment cavity, the bearing liner compressed between the containment cavity and the outer spherical surface of the bearing for non-rotatably securing of the bearing within the housing and taking up tolerances between the outer spherical surface of the bearing and the containment cavity of the containment housing.

2. The bearing assembly as set forth in claim 1 wherein the bearing liner comprises a lubricant-impregnated plastic liner having in inner spherical friction-reducing liner surface for reducing wear between the liner and the outer spherical surface during the self-alignment, the inner spherical liner surface and the outer spherical surface of the bearing having radii approximately equal to each other.

3. The bearing assembly as set forth in claim 1 wherein the bearing liner includes a compressible liner portion projecting from the outer portion of the liner for accommodating tolerance between the containment cavity of the containment housing and the outer spherical surface of the bearing and providing a tight grip of the inner spherical surface of the liner on the outer race.

4. The bearing assembly as set forth in claim 3 wherein the compressible liner portion includes on O-ring supported by the plastic liner.

5. The bearing assembly as set forth in claim 3 wherein the compressible liner portion comprises protrusions molded into the liner.

6. The bearing assembly as set forth in claim 3 wherein compressible liner portion comprises first and second liner halves assembled over the spherical bearing, the liner halves including compressible projections and anti-rotation tabs projecting radially from the halves, wherein the containment housing includes mating recesses receiving the anti-rotation tabs.

7. The bearing assembly as set forth in claim 3 wherein the bearing liner comprises a plastic material molded directly into the containment cavity of the containment housing.

8. The bearing assembly as set forth in claim 1 wherein the liner comprises an inner self-lubricating outer race support and a compressible liner portion bearing against the housing surfaces and urging the liner against the outer race.

9. The bearing assembly as set forth in claim 8 wherein the self-lubricating outer race support comprises a first high strength self-lubricating plastic material and the compressible liner portion comprises a second plastic material of durometer less than the first plastic material.

10. The bearing assembly as set forth in claim 8 wherein the compressible liner portion includes plastic compressible projections extending radially outwardly from the outer portion of the liner to bias the outer race support into engagement with the outer race.

11. The bearing assembly as set forth in claim 1 wherein the improvement further comprises:
the liner fabricated from a self-lubricating plastic material;
the bearing comprising a sealed pre-lubricated bearing; and
wherein the bearing assembly is void of external grease ports.

12. In a self-aligning bearing assembly for supporting an implement shaft for rotation about a shaft axis in a harsh operating environment, the shaft axis moveable a limited amount from a first aligned position, the assembly including a bearing with an outer race and an outer spherical surface, a bearing inner race supported within the outer race for rotation about an inner race axis, and a containment housing defining a containment cavity supporting the outer spherical surface and facilitating movement of the inner race for self-alignment of the inner race axis with the shaft axis as the shaft axis moves from the first aligned position, structure for securing the bearing within the containment housing, the improvement comprising;
a bearing liner fabricated from a self-lubricating plastic material compressed between the containment cavity and the outer race;
the bearing comprising a sealed pre-lubricated bearing; and
wherein the bearing assembly is void of external grease ports.

13. The bearing assembly as set forth in claim 12 wherein the plastic material is molded with an outer surface conforming generally to the containment cavity and an inner spherical surface conforming to a portion of the outer spherical surface.

14. The bearing assembly as set forth in claim 12 wherein the bearing liner includes a compressible liner portion projecting from the liner for accommodating tolerance between the containment cavity of the containment housing and the outer spherical surface of the bearing and providing a tight grip of the inner spherical surface of the liner on the outer race.

15. The bearing assembly as set forth in claim 14 wherein the compressible liner portion includes a resilient band member.

16. The bearing assembly as set forth in claim 14 wherein the compressible liner portion comprises protrusions molded into the liner.

17. The bearing assembly as set forth in claim 14 wherein compressible liner portion comprises first and second molded liner halves assembled over the bearing, the liner halves including compressible projections and locating tabs projecting radially from the halves, wherein the containment housing includes mating recesses receiving the locating tabs.

18. The bearing assembly as set forth in claim 12 wherein the bearing liner comprises a plastic material molded directly into the containment cavity of the containment housing.

19. The bearing assembly as set forth in claim 12 wherein the bearing liner comprises an inner self-lubricating outer race support and a compressible liner portion bearing against the housing surfaces and urging the liner against the outer race.

20. The bearing assembly as set forth in claim 19 wherein the self-lubricating outer race support comprises a high strength self-lubricating first plastic material and the compressible liner portion comprises a second plastic material of durometer less than the first plastic material.
